(19) United States
(12) Patent Application Publication
(10) Pub. No.: US 2011/0055430 A1
(43) Pub. Date: Mar. 3, 2011

(54) METHOD FOR ESTABLISHING A COMMUNICATION CHANNEL BETWEEN A HOST DEVICE AND A MEMORY DEVICE, ASSOCIATED MEMORY DEVICE AND CONTROLLER THEREOF, AND ASSOCIATED HOST DEVICE AND HOST DEVICE APPLICATION

(76) Inventors: Bo Chen, San Jose, CA (US); Wei-Qing Li, Shanghai (CN)

(21) Appl. No.: 12/757,049

(22) Filed: Apr. 9, 2010

(30) Foreign Application Priority Data
Sep. 2, 2009 (TW) 098129597

(51) Int. Cl. G06F 3/00; G06F 12/02

(52) U.S. Cl. 710/5; 710/15; 711/103; 710/11; 711/E12.008

(57) ABSTRACT

A method for establishing a communication channel between a host device and a memory device including a Flash memory includes: detecting at least one content that is transmitted from the host device to the memory device; and when it is detected that any content that the host device writes into a file after opening the file is at least one predetermined signature code, determining the communication channel to be established, and processing at least one portion of information that the host device writes into the file after sending the predetermined signature code by regarding the at least one portion of the information as communication contents that the host device sends to the memory device through the communication channel until the communication channel is canceled. An associated memory device and a controller thereof, and an associated host device and an associated host device application are also provided.

### BACKGROUND OF THE INVENTION

1. Field of the Invention

The present invention relates to Flash memory control, and more particularly, to a method for establishing a communication channel between a host device and a memory device, an associated memory device and a controller thereof, and an associated host device and an associated host device application.

2. Description of the Prior Art

As technologies of Flash memories progress in recent years, many kinds of portable memory devices, such as memory cards respectively complying with SD/MMC, CF, MS, and XD standards, are widely implemented in various applications. Therefore, the control of access to Flash memories in these portable memory devices has become an important issue.

Taking NAND Flash memories as an example, they can mainly be divided into two types, i.e. Single Level Cell (SLC) Flash memories and Multiple Level Cell (MLC) Flash memories. Each transistor that is considered a memory cell in SLC Flash memories only has two charge levels that respectively represent a logical value 0 and a logical value 1. In addition, the storage capability of each transistor that is considered a memory cell in MLC Flash memories can be fully utilized. More specifically, the voltage for driving memory cells in the MLC Flash memories is typically higher than that in the SLC Flash memories, and different voltage levels can be applied to the memory cells in the MLC Flash memories in order to record information of two bits (e.g. binary values 00, 01, 11, or 10) in a transistor that is considered a memory cell. Theoretically, the storage density of the MLC Flash memories may reach twice the storage density of the SLC Flash memories, which is considered good news for NAND Flash memory manufacturers who encountered a bottleneck of NAND Flash technologies.

As MLC Flash memories are cheaper than SLC Flash memories, and are capable of providing higher capacity than SLC Flash memories while the space is limited, MLC Flash memories have been a main stream for implementation of most portable memory devices on the market. However, various problems of the MLC Flash memories have arisen due to their unstable characteristics. In response to these problems, a conventional portable memory device may perform some management operations that are considered necessary, by utilizing the controller therein. Once the portable memory device has become a handy product owned by an end-user, typically, the portable memory device manufacturer of this product can change or update the management method of the portable memory device only by replacing the product that has been sold to the end-user with a new one or by taking the product from the end-user and then sending back the modified product to the end-user.

Thus, according to the related art, there is no handy method for changing or updating the management of the portable memory device, and additional costs are required and the time of the end-user is wasted. Therefore, a novel method is required for enhancing the control of a Flash memory in a portable memory device, in order to guarantee that the management of the portable memory device can be changed or updated with ease in a situation where the portable memory device has become a handy product owned by an end-user.

### SUMMARY OF THE INVENTION

It is therefore an objective of the claimed invention to provide a method for establishing a communication channel between a host device and a memory device, to provide an associated memory device and a controller thereof, and to provide an associated host device and an associated host device application, in order to solve the above-mentioned problems.

It is another objective of the claimed invention to provide a method for establishing a communication channel between a host device and a memory device, to provide an associated memory device and a controller thereof, and to provide an associated host device and an associated host device application, in order to manage operations of the memory device through the host device application, and more particularly, to manage basic operations of the memory device (e.g. a portable memory device).

According to a preferred embodiment of the claimed invention, a method for establishing a communication channel between a host device and a memory device is provided. The memory device comprises a Flash memory. The method comprises: detecting at least one content that is transmitted from the host device to the memory device; and when it is detected that any content that the host device writes into a file after opening the file is at least one predetermined signature code, determining the communication channel to be established, and processing at least one portion of information that the host device writes into the file after sending the predetermined signature code by regarding the at least one portion of the information as communication contents that the host device sends to the memory device through the communication channel until the communication channel is canceled.

While the method mentioned above is disclosed, an associated memory device is further provided. The memory device comprises: a Flash memory comprising a plurality of blocks; and a controller arranged to access the Flash memory and manage the plurality of blocks. In addition, the controller further operates according to a method for establishing a communication channel between a host device and the memory device, and the method comprises: detecting at least one content that is transmitted from the host device to the memory device; and when it is detected that any content that the host device writes into a file after opening the file is at least one predetermined signature code, determining the communication channel to be established, and processing at least one portion of information that the host device writes into the file after sending the predetermined signature code by regarding the at least one portion of the information as communication contents that the host device sends to the memory device through the communication channel until the communication channel is canceled.

While the method mentioned above is disclosed, a controller of a memory device is further provided, wherein the controller is utilized for accessing a Flash memory comprising a plurality of blocks. The controller comprises: a read only memory (ROM) arranged to store a program code; and a microprocessor arranged to execute the program code to control the access to the Flash memory and manage the plurality of blocks. In addition, the controller that executes the program code by utilizing the microprocessor further operates according to a method for establishing a communication channel between a host device and the memory device, and the method comprises: detecting at least one content that is transmitted from the host device to the memory device; and when it is detected that any content that the host device writes into a file after opening the file is at least one predetermined signature code, determining the communication channel to be established, and processing at least one portion of information that the host device writes into the file after sending the predetermined signature code by regarding the at least one portion of the information as communication contents that the host device sends to the memory device through the communication channel until the communication channel is canceled.

While the method mentioned above is disclosed, an associated host device is further provided. The host device comprises: a memory device interface module arranged to electronically connect a memory device; and a controller arranged to control operations of the host device and access a Flash memory within the memory device through the memory device interface module. In addition, the controller further operates according to a method for establishing a communication channel between the host device and the memory device, and the method comprises: opening a file regarding the memory device; and after opening the file, writing at least one predetermined signature code into the file to establish the communication channel. Additionally, at least one portion of information that the host device writes into the file after sending the predetermined signature code represents communication contents that the host device sends to the memory device through the communication channel until the communication channel is canceled.

While the host device mentioned above is disclosed, an associated host device application is further provided. The host device application is utilized for being executed by a host device to make the host device operate according to a method for establishing a communication channel between the host device and a memory device, where the memory device comprises a Flash memory. The method comprises: opening a file regarding the memory device; and after opening the file, writing at least one predetermined signature code into the file to establish the communication channel. Additionally, at least one portion of information that the host device writes into the file after sending the predetermined signature code represents communication contents that the host device sends to the memory device through the communication channel until the communication channel is canceled.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a memory device according to a first embodiment of the present invention.

FIG. 2 is a flowchart of a method for establishing a communication channel between a host device and a memory device according to an embodiment of the present invention.

FIG. 3 illustrates a diagram of a communication channel between a host device and the memory device shown in FIG. 1 according to an embodiment of the present invention.

FIGS. 4-8 illustrate implementation details of a predetermined communication protocol involved with the method shown in FIG. 2 according to an embodiment of the present invention.

FIG. 9 illustrates implementation details of a reading control process involved with the method shown in FIG. 2 according to an embodiment of the present invention.

FIG. 10 illustrates implementation details of a writing control process involved with the method shown in FIG. 2 according to an embodiment of the present invention.

### DETAILED DESCRIPTION

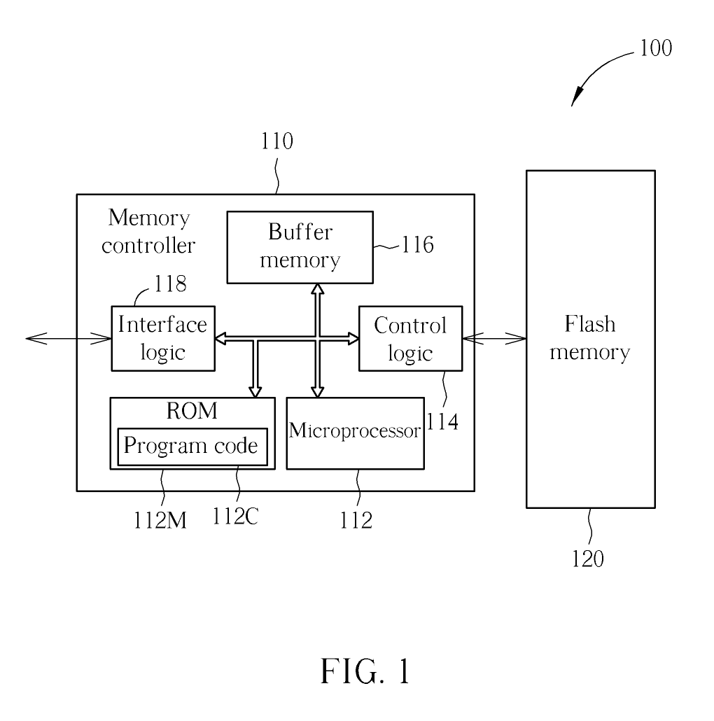

Please refer to FIG. 1, which illustrates a diagram of a memory device 100 according to a first embodiment of the present invention. In particular, the memory device 100 of this embodiment is a portable memory device, such as a memory card complying with SD/MMC, CF, MS, or XD standards. The memory device 100 comprises a Flash memory 120, and further comprises a controller arranged to access the Flash memory 120, where the aforementioned controller of this embodiment is a memory controller 110. According to this embodiment, the memory controller 110 comprises a microprocessor 112, a read only memory (ROM) 112M, a control logic 114, a buffer memory 116, and an interface logic 118. The ROM 112M is arranged to store a program code 112C, and the microprocessor 112 is arranged to execute the program code 112C to control the access to the Flash memory 120. Please note that, according to different variations of this embodiment, the program code 112C can be stored in the buffer memory 116 or any other memory.

Typically, the Flash memory 120 comprises a plurality of blocks, and the controller (e.g. the memory controller 110 that executes the program code 112C by utilizing the microprocessor 112) performs data erasure operations on the Flash memory 120 by erasing in units of blocks. In addition, a block can be utilized for recording a specific amount of pages, where the controller mentioned above performs data writing operations on the Flash memory 120 by writing/programming in units of pages.

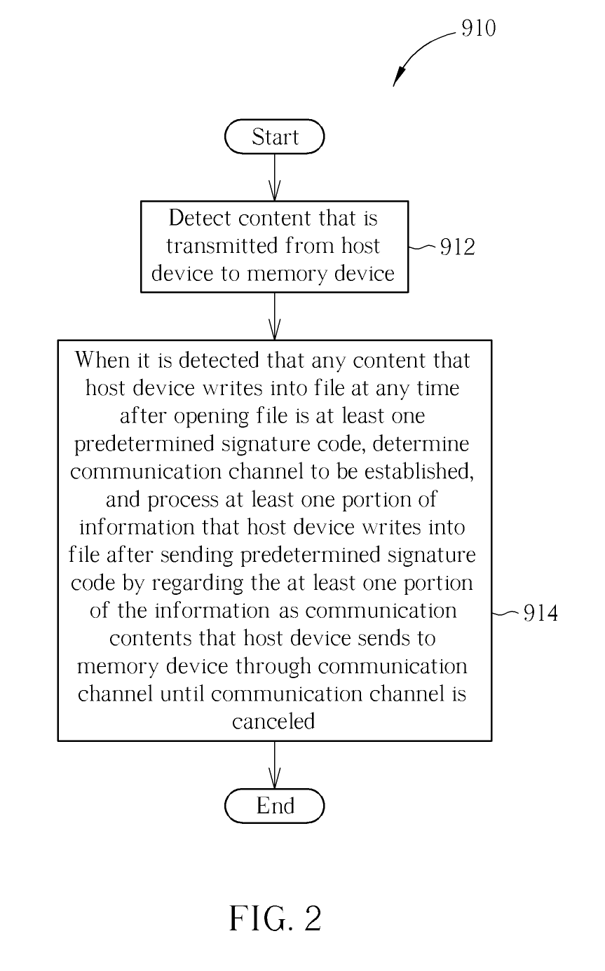

In practice, the memory controller 110 that executes the program code 112C by utilizing the microprocessor 112 is capable of performing various control operations by utilizing the internal components within the memory controller 110. For example, the memory controller 110 utilizes the control logic 114 to control access to the Flash memory 120 (e.g. operations of accessing at least one block or at least one page), utilizes the buffer memory 116 to perform buffering operations for the memory controller 110, and utilizes the interface logic 118 to communicate with a host device. According to this embodiment, in addition to accessing the Flash memory 120 based upon control by the host device, the controller is capable of properly managing the plurality of blocks. In addition, the memory controller 110 that executes the program code 112C by utilizing the microprocessor 112 is capable of operating according to a method for establishing a communication channel between the host device and the memory device 100. Please refer to FIG. 2 for details.

FIG. 2 is a flowchart of a method 910 for establishing a communication channel between a host device and a memory device according to an embodiment of the present invention. The method can be applied to the memory device 100 shown in FIG. 1, and more particularly, to the controller mentioned above (e.g. the memory controller 110 that executes the program code 112C by utilizing the microprocessor 112). In addition, the method can be implemented by utilizing the memory device 100 shown in FIG. 1, and more particularly, by utilizing the controller mentioned above. The method 910 is described as follows.

In Step 912, the aforementioned controller (e.g. the memory controller 110 that executes the program code 112C by utilizing the microprocessor 112) detects at least one content that is transmitted from the host device to the memory device 100.

In Step 914, when it is detected that any content that the host device writes into a file at any time after opening the file is at least one predetermined signature code, the aforementioned controller determines the communication channel to be established, and processes at least one portion of information that the host device writes into the file after sending the predetermined signature code by regarding the at least one portion of the information as communication contents that the host device sends to the memory device 100 through the communication channel until the communication channel is canceled. More particularly, in a special case of this embodiment, the aforementioned at least one portion of information represents information that the host device writes into a signed region of the file after sending the predetermined signature code, where the controller processes by regarding other region(s) of the file as a normal file. According to a variation of this embodiment, the signed region is a signed block. According to another special case of this embodiment, the aforementioned at least one portion of information represents all of the information that the host device writes into the file after sending the predetermined signature code.

According to this embodiment, the predetermined signature code is a unique universal identification (ID). In particular, the predetermined signature code comprises 128 or more bits. This is for illustrative purposes only, and is not meant to be a limitation of the present invention. According to a variation of this embodiment, the predetermined signature code may represent a value falling within a predetermined range. That is, in Step 914, when it is detected that the content that the host device writes into the file at any time after opening the file is a value falling within the predetermined range, the controller mentioned above determines that the predetermined signature code checking is passed. As a result, the controller determines the communication channel to be established, processes by regarding at least one portion of information that the host device writes into the file after sending the predetermined signature code as communication contents that the host device sends to the memory device 100 through the communication channel until the communication channel is canceled.

In addition, the controller mentioned above detects whether the communication contents that the host device sends to the memory device 100 through the communication channel complies with a predetermined communication protocol. Regarding implementation details of the predetermined communication protocol, please refer to the following embodiments for more information. In this embodiment, when any communication content does not comply with the predetermined communication protocol, the controller may cancel the communication channel and process the file by regarding the file as a normal file. This is for illustrative purposes only, and is not meant to be a limitation of the present invention. According to a variation of this embodiment, when any communication content does not comply with the predetermined communication protocol, the controller may selectively cancel the communication channel or provide the host device with at least one opportunity of retrying. According to another variation of this embodiment, the controller may cancel the communication channel by utilizing a cancel command complying with the predetermined communication protocol.

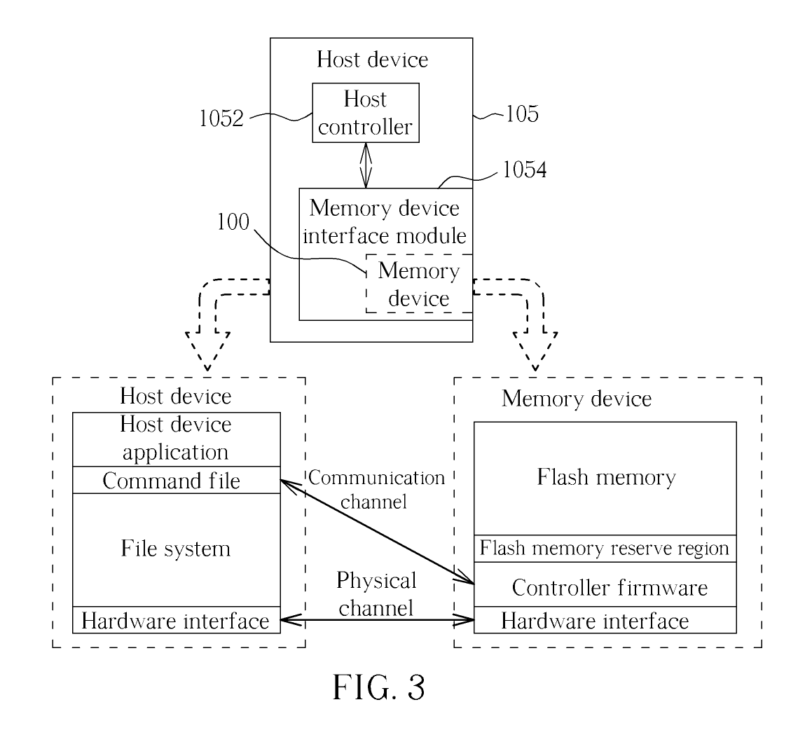

FIG. 3 illustrates a diagram of the communication channel between the host device mentioned above and the memory device 100 shown in FIG. 1 according to an embodiment of the present invention, where the host device of this embodiment can be a mobile phone. This is for illustrative purposes only, and is not meant to be a limitation of the present invention. According to a variation of this embodiment, the host device can be a Personal Digital Assistant (PDA). According to another variation of this embodiment, the host device can be a portable multi-function electronic device having mobile phone functions and/or PDA functions.

As shown in FIG. 3, the host device 105 comprises a controller such as a host controller 1052, and further comprises a memory device interface module 1054, where the memory device interface module 1054 is utilized for electronically connecting a memory device such as the memory device 100, and the host controller 1052 is utilized for controlling operations of the host device 105 and accessing the Flash memory 120 within the memory device 100 through the memory device interface module 1054. According to this embodiment, the host controller 1052 further operates according to a method for establishing the communication channel between the host device 105 and the memory device 100, and the method comprises: opening a file regarding the memory device 100 (e.g. the “Command file” shown in the bottom-left of FIG. 3); and after opening the file, writing at least one predetermined signature code into the file to establish the communication channel. Please note that the above-disclosed operation method of the host controller 1052 and the method 910 shown in FIG. 2 correspond to each other. Thus, at least one portion of information that the host device 105 writes into the file after sending the predetermined signature code represents communication contents that the host device 105 sends to the memory device 100 through the communication channel until the communication channel is canceled. More particularly, in this embodiment, a host device application is utilized for being executed by the host device 105 to make the host device 105 operate according to the above-mentioned operation method of the host controller 1052, where the host device application utilizes the command file within the file system of the host device 105 as the terminal of the communication channel at the side of the host device 105. In addition, the command file of this embodiment is a binary file. This is for illustrative purposes only, and is not meant to be a limitation of the present invention. According to a variation of this embodiment, the command file can be a text file having one or more text strings.

As shown in the lower half of FIG. 3, the communication channel is at an upper layer of a physical channel, and the physical channel represents a communication channel formed between the hardware interface of the host device 105 and the hardware interface of the memory device 100. In addition, the terminal of the communication channel shown in FIG. 3 at the side of the memory device 100 is labeled as “Controller firmware”, which represents that the program code 112C mentioned above is firmware code. This is for illustrative purposes only, and is not meant to be a limitation of the present invention. According to a variation of this embodiment, the terminal of the communication channel shown in FIG. 3 at the side of the memory device 100 can be replaced by controller hardware, where the program code 112C mentioned above can be hardware code, such as ROM Code embedded in the controller.

Please note that the “Flash memory reserve region” shown in the bottom-right of FIG. 3 is set up for specific communication contents transmitted by the communication channel. This is for illustrative purposes only, and is not meant to be a limitation of the present invention. According to a variation of this embodiment, there is no need to set up the Flash memory reserve region mentioned above within the Flash memory shown in FIG. 3.

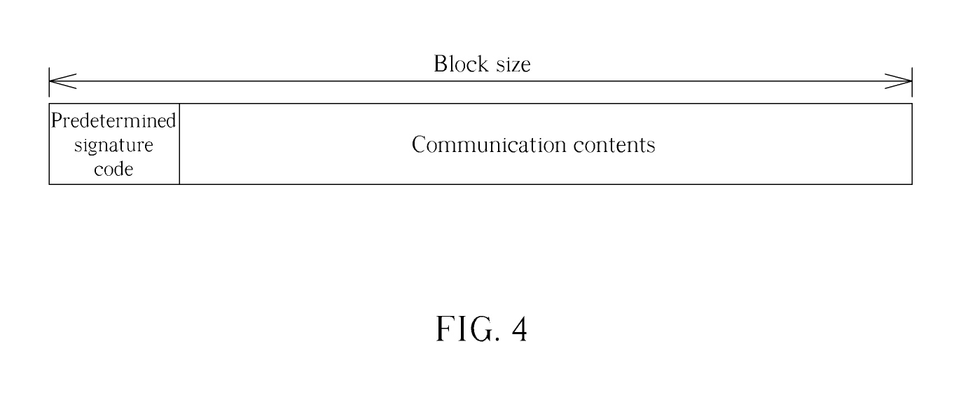

FIGS. 4-8 illustrate implementation details of the predetermined communication protocol involved with the method 910 shown in FIG. 2 according to an embodiment of the present invention, where the communication contents shown in these figures all begin with the predetermined signature code mentioned above. In addition to the predetermined signature code, the communication contents comprise at least one command parameter. For example, the command parameter indicates that a command being transmitted is a “reserve Flash memory command”, a “link block command”, a “link multiple-block command”, or a “randomly write data command”. As shown in FIG. 4, the predetermined communication protocol in this embodiment defines a unit of commands being written (or a command unit) to be equivalent to a size of a block, so the command being written at respective times can be referred to as command blocks. More particularly, a typical format of the commands being written at respective times in this embodiment all begin with the predetermined signature code, and the subsequent communication contents must comply with the predetermined communication protocol. This is for illustrative purposes only, and is not meant to be a limitation of the present invention. According to a variation of this embodiment, all the information that the host device writes into the file after sending the predetermined signature code at a certain time (e.g. the first time) has no need to carry the predetermined signature code. According to other variations of this embodiment, the predetermined communication protocol does not have to define a unit of commands being written (or a command unit) to be equivalent to a size of a block. Typically, as long as the operations of the file system and the hardware interface of the host device are not hindered, it is not required to define a unit of commands being written.

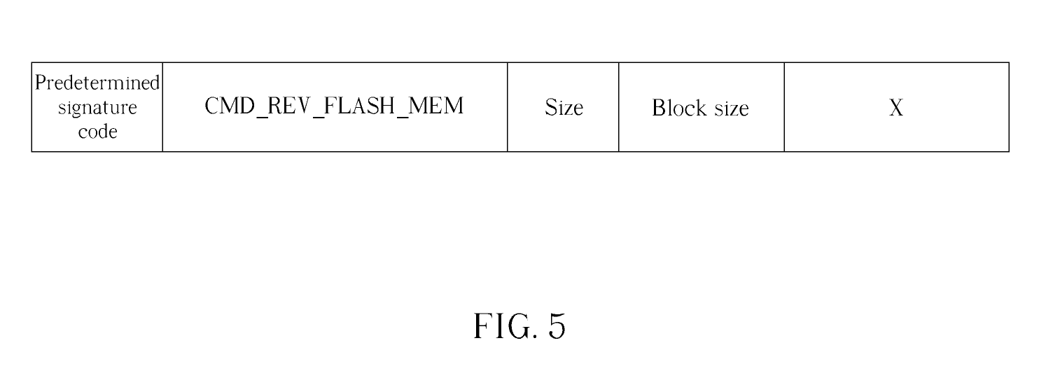

FIGS. 5-8 illustrate some examples of the command blocks of this embodiment, where each command block comprises the predetermined signature code, a command parameter, and associated field(s). For example, the command parameter CMD_REV_FLASH_MEM shown in FIG. 5 indicates that the command (or the command block) being transmitted is the aforementioned “reserve Flash memory command”, which is utilized for generating or enabling a Flash memory reserve region (e.g. the Flash memory reserve region shown in the bottom-right of FIG. 3), where the subsequent fields “Size” and “Block size” respectively represent the number of blocks of the Flash memory reserve region and the size of each block, and the remaining field labeled “X” represents a reserved field for further use of updating the predetermined communication protocol. More particularly, the block involved with this command block is a physical block, and in this situation, the fields “Size” and “Block size” mentioned above respectively represent the number of physical blocks of the Flash memory reserve region and the size of each physical block.

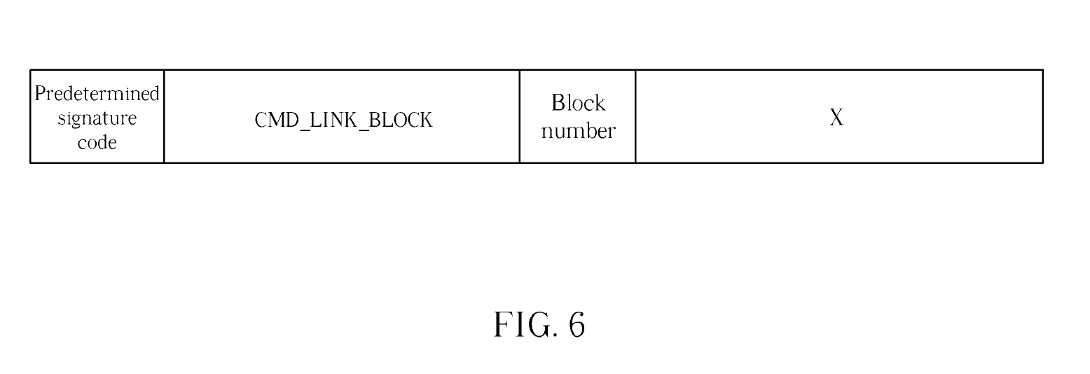

In another example, the command parameter CMD_LINK_BLOCK shown in FIG. 6 indicates that the command (or the command block) being transmitted is the aforementioned “link block command”, which is utilized for linking (or assigning) a specific physical block of the Flash memory reserve region to this command block for reading, where the subsequent field “Block number” represents the block number of the physical block to be linked (or assigned). Thus, when the host device reads this command block, the memory controller 110 sends back the contents of the physical block represented by the block number.

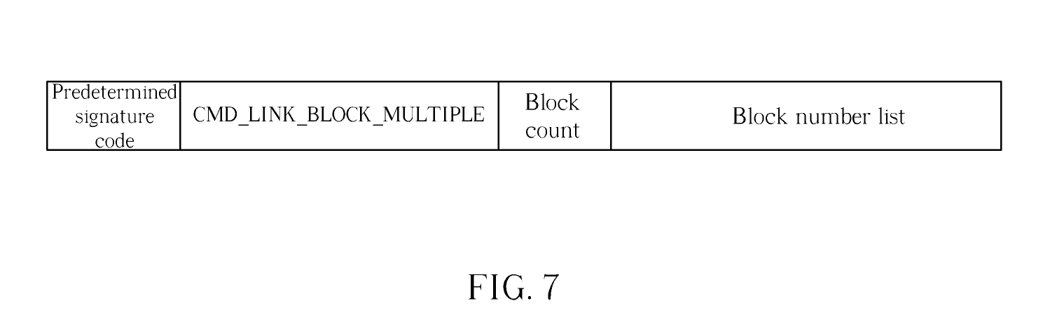

In addition, the command parameter CMD_LINK_BLOCK_MULTIPLE shown in FIG. 7 indicates that the command (or the command block) being transmitted is the aforementioned “link multiple-block command”, which is utilized for linking (or assigning) a plurality of specific physical blocks of the Flash memory reserve region to this command block for reading, where the subsequent fields “Block count” and “Block number list” respectively represent the block count of the physical blocks to be linked (or assigned) and the block numbers of these physical blocks. Thus, when the host device reads/writes this command block, the memory controller 110 reads/writes the physical blocks represented by these block numbers in the order of physical blocks as instructed by the field “Block number list”.

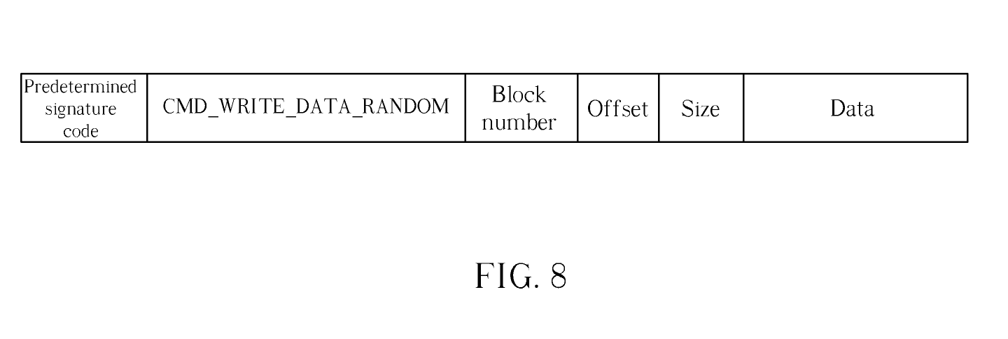

Additionally, the command parameter CMD_WRITE_DATA_RANDOM shown in FIG. 8 indicates that the command (or the command block) being transmitted is the aforementioned “randomly write data command”, which is utilized for randomly writing data, where the subsequent fields “Block number”, “Offset”, “Size”, and “Data” respectively represent the block number of the physical block to which the location of writing belongs, the offset of the location of writing with respect to the beginning of the physical block, the number of bytes of the data being written, and the contents of the data. When the host device reads this command block, the memory controller 110 sends back the contents of the physical block represented by the block number.

Please note that a conventional host device cannot control a physical block in a portable memory device. Therefore, in contrast to the related art, the present invention indeed provides a very convenient method (such as that shown in FIG. 2) to make the host device 105 capable of participating in the internal control of the memory device 100. In addition, the communication contents of this embodiment are involved with the access to the Flash memory 120 or the management of the Flash memory 120. This is for illustrative purposes only, and is not meant to be a limitation of the present invention. According to a variation of this embodiment, the communication contents can be utilized for controlling the memory device 100 to perform some other operations. For example, the communication contents can be utilized for instructing the memory controller 110 to perform some bottom layer control operations. In another example, the communication contents can be utilized for instructing the memory controller 110 to change the control over the memory device 100 or change an operation mode of the memory device 100. According to another variation of this embodiment, the communication contents can be utilized for updating the program code 112C.

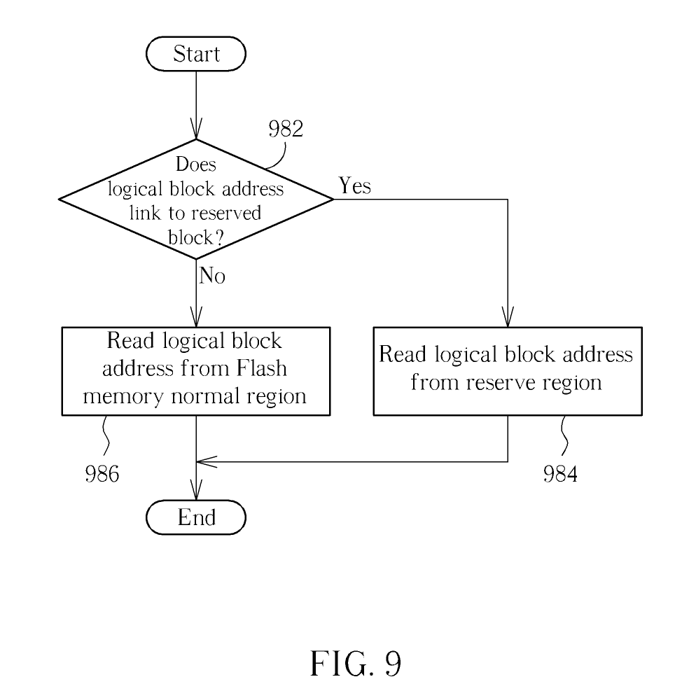

FIG. 9 illustrates implementation details of a reading control process involved with the method 910 shown in FIG. 2 according to an embodiment of the present invention, where the reading control process is utilized for controlling a reading operation regarding a logical block address, and is described as follows.

In Step 982, the memory controller 110 determines whether the logical block address links to a reserved block. When it is detected that the logical block address links to the reserved block, Step 984 is entered; otherwise, Step 986 is entered.

In Step 984, the memory controller 110 reads the logical block address from the reserve region. In this step, the operation of reading the logical block address means performing the reading operation at the logical block address. According to this embodiment, the memory controller 110 determines whether the logical block address links to a physical block (i.e. a physical block in the Flash memory reserve region). When it is detected that the logical block address links to a physical block, the reserve region mentioned above represents the Flash memory reserve region, so the memory controller 110 reads the logical block address from the Flash memory reserve region; otherwise, the reserve region mentioned above represents a virtual block, so the memory controller 110 reads the logical block address from the virtual block.

In Step 986, the memory controller 110 reads the logical block address from the Flash memory normal region (which comprises normal blocks of the Flash memory 120, and more particularly, the blocks that do not belong to the Flash memory reserve region). Similarly, in this step, the operation of reading the logical block address means performing the reading operation at the logical block address.

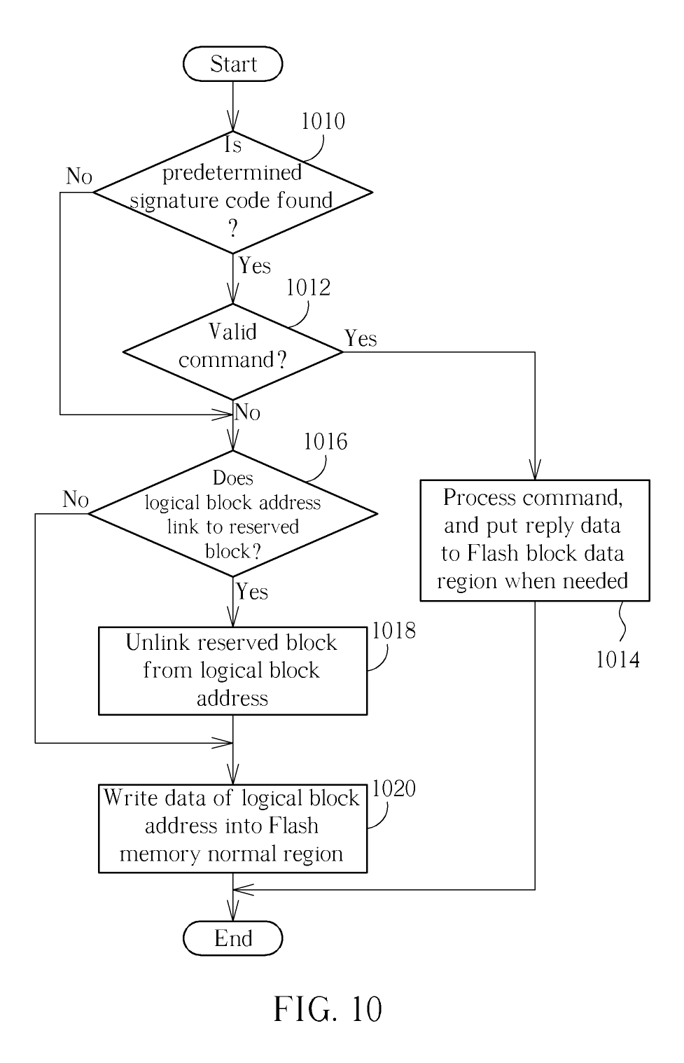

FIG. 10 illustrates implementation details of a writing control process involved with the method 910 shown in FIG. 2 according to an embodiment of the present invention, where the writing control process is utilized for controlling a writing operation regarding a logical block address, and is described as follows.

In Step 1010, the memory controller 110 determines whether the predetermined signature code is found. When the memory controller 110 detects the predetermined signature code, Step 1012 is entered; otherwise, Step 1016 is entered.

In Step 1012, the memory controller 110 determines whether the currently received communication content is a valid command, and more particularly, determines whether the currently received communication content comply with a predetermined communication protocol such as that mentioned above. When it is detected that the currently received communication content is a valid command, Step 1014 is entered; otherwise, Step 1016 is entered.

In Step 1014, the memory controller 110 processes the command, and puts reply data (e.g. the data to be sent back) to the Flash block data region when needed.

In Step 1016, the memory controller 110 determines whether the logical block address links to a reserved block. When it is detected that the logical block address links to the reserved block, Step 1018 is entered; otherwise, Step 1020 is entered.

According to this embodiment, the reserved block mentioned above may represent a block belonging to the Flash memory reserve region, or represent a virtual block. The memory controller 110 is capable of determining whether the logical block address links to a physical block (i.e. a physical block in the Flash memory reserve region). When it is detected that the logical block address links to a physical block, the reserved block mentioned above represents a block in the Flash memory reserve region, and is utilized for accessing data or other information; otherwise, the reserved block mentioned above represents a virtual block (i.e. a block that does not have any portion of a physical storage medium), and in this situation, the typical communication content may comprise a command or a command parameter, which have no need to be stored.

In Step 1018, the memory controller 110 unlinks the reserved block from the logical block address.

In Step 1020, the memory controller 110 writes the data of the logical block address into the Flash memory normal region (which comprises normal blocks of the Flash memory 120, and more particularly, the blocks that do not belong to the Flash memory reserve region).

In contrast to the related art, when it is required to change or update the management of the portable memory device, the present invention can effectively save costs and save the time of the end-user. According to the present invention, once the portable memory device has become a handy product owned by the end-user, as long as the portable memory device manufacturer of this product provides the end-user with the host device application that is implemented according to the present invention, improving the portable memory device or updating the internal program code therein (e.g. the program code 112C) can be carried out with ease by utilizing the communication channel to perform basic operation management. Therefore, the portable memory device manufacturer neither has to replace the product that has been sold to the end-user with a new one nor has to take the product from the end-user and then send back the modified product to the end-user.

It is another advantage of the present invention that the communication channel established according to the present invention can be utilized for performing basic operation management. Even in a situation where the file system of the host device is damaged and is then re-established, the implementation of the present invention will not be hindered. In addition, as the present invention method is practical and reliable, the host device manufacturer or the portable memory device manufacturer can develop host device applications complying with the predetermined communication protocol, based upon real need, in order to properly manage the operations of the portable memory device and further optimize the operations of the host device.

Those skilled in the art will readily observe that numerous modifications and alterations of the device and method may be made while retaining the teachings of the invention.

What is claimed is:

1. A method for establishing a communication channel between a host device and a memory device, the memory device comprising a Flash memory, the method comprising:
detecting at least one content that is transmitted from the host device to the memory device; and
when it is detected that any content that the host device writes into a file after opening the file is at least one predetermined signature code, determining the communication channel to be established, and processing at least one portion of information that the host device writes into the file after sending the predetermined signature code by regarding the at least one portion of the information as communication contents that the host device sends to the memory device through the communication channel until the communication channel is canceled.

2. The method of claim 1, wherein the communication channel is at an upper layer of a physical channel, and the physical channel represents a communication channel formed between a hardware interface of the host device and a hardware interface of the memory device.

3. The method of claim 1, wherein the predetermined signature code is a unique universal identification (ID).

4. The method of claim 1, wherein the predetermined signature code represents a value falling within a predetermined range.

5. The method of claim 1, further comprising:
detecting whether the communication contents that the host device sends to the memory device through the communication channel complies with a predetermined communication protocol; and
when any communication content does not comply with the predetermined communication protocol, cancelling the communication channel and processing the file by regarding the file as a normal file.

6. The method of claim 1, further comprising:
detecting whether the communication contents that the host device sends to the memory device through the communication channel complies with a predetermined communication protocol; and
when any communication content does not comply with the predetermined communication protocol, selectively cancelling the communication channel or providing the host device with at least one opportunity of retrying.

7. The method of claim 1, wherein the communication contents comprise at least one command parameter; and the command parameter indicates that a command being transmitted is a reserve Flash memory command, a link block command, a link multiple-block command, or a randomly write data command.

8. A memory device, comprising:
a Flash memory comprising a plurality of blocks; and
a controller arranged to access the Flash memory and manage the plurality of blocks, wherein the controller further operates according to a method for establishing a communication channel between a host device and the memory device, and the method comprises:
detecting at least one content that is transmitted from the host device to the memory device; and
when it is detected that any content that the host device writes into a file after opening the file is at least one predetermined signature code, determining the communication channel to be established, and processing at least one portion of information that the host device writes into the file after sending the predetermined signature code by regarding the at least one portion of the information as communication contents that the host device sends to the memory device through the communication channel until the communication channel is canceled.

9. The memory device of claim 8, wherein the communication channel is at an upper layer of a physical channel, and the physical channel represents a communication channel formed between a hardware interface of the host device and a hardware interface of the memory device.

10. The memory device of claim 8, wherein the predetermined signature code is a unique universal identification (ID).

11. The memory device of claim 8, wherein the predetermined signature code represents a value falling within a predetermined range.

12. The memory device of claim 8, wherein the controller detects whether the communication contents that the host device sends to the memory device through the communication channel complies with a predetermined communication protocol; and when any communication content does not comply with the predetermined communication protocol, the controller cancels the communication channel and processes the file by regarding the file as a normal file.

13. The memory device of claim 8, wherein the controller detects whether the communication contents that the host device sends to the memory device through the communication channel complies with a predetermined communication protocol; and when any communication content does not comply with the predetermined communication protocol, the controller selectively cancels the communication channel or provides the host device with at least one opportunity of retrying.

14. The memory device of claim 8, wherein the communication contents comprise at least one command parameter; and the command parameter indicates that a command being transmitted is a reserve Flash memory command, a link block command, a link multiple-block command, or a randomly write data command.

15. A controller of a memory device, the controller being utilized for accessing a Flash memory comprising a plurality of blocks, the controller comprising:
a read only memory (ROM) arranged to store a program code; and
a microprocessor arranged to execute the program code to control the access to the Flash memory and manage the plurality of blocks, wherein the controller that executes the program code by utilizing the microprocessor further operates according to a method for establishing a communication channel between a host device and the memory device, and the method comprises:
detecting at least one content that is transmitted from the host device to the memory device; and
when it is detected that any content that the host device writes into a file after opening the file is at least one predetermined signature code, determining the communication channel to be established, and processing at least one portion of information that the host device writes into the file after sending the predetermined signature code by regarding the at least one portion of the information as communication contents that the host device sends to the memory device through the communication channel until the communication channel is canceled.

16. The controller of claim 15, wherein the communication channel is at an upper layer of a physical channel, and the physical channel represents a communication channel formed between a hardware interface of the host device and a hardware interface of the memory device.

17. The controller of claim 15, wherein the predetermined signature code is a unique universal identification (ID).

18. The controller of claim 15, wherein the predetermined signature code represents a value falling within a predetermined range.

19. The controller of claim 15, wherein the controller that executes the program code by utilizing the microprocessor detects whether the communication contents that the host device sends to the memory device through the communication channel complies with a predetermined communication protocol; and when any communication content does not comply with the predetermined communication protocol, the controller that executes the program code by utilizing the microprocessor cancels the communication channel and processes the file by regarding the file as a normal file.

20. The controller of claim 15, wherein the controller that executes the program code by utilizing the microprocessor detects whether the communication contents that the host device sends to the memory device through the communication channel complies with a predetermined communication protocol; and when any communication content does not comply with the predetermined communication protocol, the controller that executes the program code by utilizing the microprocessor selectively cancels the communication channel or provides the host device with at least one opportunity of retrying.

21. The controller of claim 15, wherein the communication contents comprise at least one command parameter; and the command parameter indicates that a command being transmitted is a reserve Flash memory command, a link block command, a link multiple-block command, or a randomly write data command.

22. A host device, comprising:
a memory device interface module arranged to electronically connect a memory device; and
a controller arranged to control operations of the host device and access a Flash memory within the memory device through the memory device interface module, wherein the controller further operates according to a method for establishing a communication channel between the host device and the memory device, and the method comprises:
opening a file regarding the memory device; and
after opening the file, writing at least one predetermined signature code into the file to establish the communication channel;
wherein at least one portion of information that the host device writes into the file after sending the predetermined signature code represents communication contents that the host device sends to the memory device through the communication channel until the communication channel is canceled.

23. A host device application, for being executed by a host device to make the host device operate according to a method for establishing a communication channel between the host device and a memory device, the memory device comprising a Flash memory, the method comprising:
opening a file regarding the memory device; and
after opening the file, writing at least one predetermined signature code into the file to establish the communication channel;
wherein at least one portion of information that the host device writes into the file after sending the predetermined signature code represents communication contents that the host device sends to the memory device through the communication channel until the communication channel is canceled.
